(19) United States
(12) Patent Application Publication
(10) Pub. No.: US 2025/0052627 A1
(43) Pub. Date: Feb. 13, 2025

(54) PRESSURE-DETECTING PANEL

(71) Applicant: NISSHA CO.,LTD., Kyoto (JP)

(72) Inventor: Takashi YOKOYAMA, Kyoto (JP)

(73) Assignee: NISSHA CO.,LTD., Kyoto (JP)

(21) Appl. No.: 18/718,310

(22) PCT Filed: Mar. 23, 2023
(86) PCT No.: PCT/JP2023/011637

§ 371 Date: Jun. 10, 2024

(30) Foreign Application Priority Data
Apr. 21, 2022 (JP) 2022-070311

(51) Int. Cl. G01L 1/22

(52) U.S. Cl. CPC G01L 1/2287

(57) ABSTRACT

[Object]

To provide a pressure detection panel that allows suppressing the cost required for an FPC and obtaining in-plane uniformity of a detection signal of a pressing force even when a panel size is large.

[Solution]

A pressure detection panel 1 of the present invention includes a surface panel 2 and one strain sensor 3 arranged on a back surface of the surface panel 2 in a strip shape along one side of the surface panel 2. The strain sensor 3 includes sensitive units R1, R2, and R3 at an intermediate portion and both end portions in a longitudinal direction. The adjacent sensitive units, that is, the sensitive units R1 and R2 and the sensitive units R2 and R3, are mutually connected in series by a wiring line 31.

### TECHNICAL FIELD

The present invention relates to a pressure detection panel that detects a pressing force by a strain sensor provided on a back surface of a surface panel.

### BACKGROUND ART

Conventionally, various types of pressure detection panels have been known as devices that are incorporated in electronic equipment, such as displays of automobiles, control switches, handy terminals, and consoles for manufacturing equipment, and necessary information is input by pressing a specific region on a surface panel with a finger or the like to operate the equipment.

As a general pressure detection panel, there is a touch panel. There are many types of touch panels, such as a resistance film type, a surface acoustic wave type, an infrared type, and an electromagnetic induction type, in addition to an electrostatic capacitance type, which is currently the mainstream. However, in either method, there is a problem that it is necessary to cover the entire operation surface with an electrode or the cost of a device is high. Therefore, a pressure detection panel in which the amount of strain of the surface panel caused by pressure is measured by a strain sensor has been proposed.

As illustrated in FIG. 7, a well-known pressure detection panel 11 includes respective strain sensors 13a, 13b, 13c, and 13d disposed at four corners of a rectangular surface panel 12. Each of the strain sensors 13a to 13d is constituted by a resistor formed on the surface panel 12 by means of printing or the like (see Patent Document 1).

When an end portion of the surface panel 12 is fixed to a housing (not illustrated) and a pressing force is applied to the surface panel 12 by a finger or the like, a strain occurs in the surface panel 12. At this time, the strain occurs not only in the surface panel 12 but also in the strain sensors 13a, 13b, 13c, and 13d formed thereon. In the strain sensors 13a, 13b, 13c, and 13d, a change in the amount of strain appears as a change in an electrical resistance value, which is calculated by a calculation circuit (not illustrated) to detect the pressing force.

### CITATION LIST

### Patent Literature

Patent Document 1: JP 2001-265518 A

### SUMMARY OF INVENTION

### Technical Problem

However, to detect a pressing force using the above-described pressure detection panel 11, there is a problem in that external connection terminals are required for the respective strain sensors 13a to 13d arranged at the four corners and the number of terminals is large, and further a width of an FPC in which all the terminals are gathered at one place on an outer edge of the panel and connected is large, and thus the cost is increased.

In addition, in a case where the panel size is large, when a pressing force is applied to the surface panel 12 with a finger or the like, the surface panel 12 is relatively less likely to be deformed at both end portions in a direction parallel to one side of a display panel 12 than at an intermediate portion in the direction parallel to one side. Therefore, in the strain sensors 13a to 13d arranged at the four corners where the surface panel 12 is less likely to be deformed, the change in the resistance value detected according to the strain is small, and it is difficult to sufficiently detect the pressing force.

As a matter of course, when the sizes of the strain sensors 13a to 13d arranged at the four corners are increased to increase sensitivities, even the strain sensors 13a to 13d arranged at the four corners where the surface panel 12 is less likely to be deformed have the large change in the resistance value and can sufficiently detect the pressing force.

However, when the sensitivities of the strain sensors 13a to 13d arranged at the four corners are increased, there is a large difference in the change in the resistance value detected depending on a location of the pressing on the surface panel 12, and in-plane evenness of the press detection cannot be obtained.

Therefore, an object of the present invention is to solve the above-described problems and to provide a pressure detection panel that allows suppressing the cost required for an FPC and obtaining in-plane uniformity of a detection signal of a pressing force even when a panel size is large.

### Solution to Problem

Some aspects will be described below as means to solve the problems. These aspects can be combined randomly as necessary.

A pressure detection panel according to one aspect of the present invention includes a surface panel and a strain sensor. One strain sensor is arranged on a back surface of the surface panel in a strip shape along one side of the surface panel. The strain sensor includes sensitive units at an intermediate portion and both end portions in a longitudinal direction. The adjacent sensitive units are mutually connected in series by a wiring line.

In the pressure detection panel configured as described above, since only one strain sensor is provided, a width of an FPC for connection with an external device can be reduced, which saves cost.

Since the strain sensor includes the three sensitive units at the intermediate portion and both end portions of one side, it is possible to adjust sensitivities in the strain sensor to be different so as to obtain in-plane uniformity of a detection signal of a pressing force even when a panel size is large.

In the pressure detection panel described above, the sensitive unit of the strain sensor can be an element formed by repeatedly folding a linear resistor in parallel.

The pressure detection panel configured as described above can be a strain sensor in which the sensing unit has high sensitivity.

In the above-described pressure detection panel, in the longitudinal direction of the strain sensor, respective sections where the sensitive units are provided can be longer at both the end portions than at the intermediate portion.

In the pressure detection panel configured as described above, since the sensitivity of each of the sensitive units provided at both end portions of one side is adjusted to be high and the sensitivity of the sensitive unit provided at the intermediate portion of one side is adjusted to be low, even when the panel size is large, the in-plane uniformity of the detection signal of the pressing force can be obtained.

In the above-described pressure detection panel, in the longitudinal direction of the strain sensor, each section where one wiring line is provided can be one third or more of a minimum section among the respective sections where the sensitive units are provided.

In the pressure detection panel configured as described above, since a distance between the sensitive units is sufficient, the pressing force can be detected more accurately.

In the above-described pressure detection panel, the surface panel can have a quadrangular shape.

In the above-described pressure detection panel, the strain sensor can be further arranged on at least one side of remaining sides of the surface panel.

Since the pressure detection panel configured as described above also detects strain on the other sides, it is possible to more accurately detect the pressing force.

In the pressure detection panel described above, the strain sensor can include a total of three sensitive units, one at each of the intermediate portion and both the end portions. In the pressure detection panel configured as described above, since there are only the three sensitive units, the distance between the mutual sensitive units can be easily obtained, and the pressing force can be detected more accurately.

Of course, depending on a degree of an increase in panel size, the strain sensor can include a total of four or more sensitive units, two or more at the intermediate portion, and one or more at each of both the end portions.

### Advantageous Effects of Invention

The pressure detection panel of the present invention can suppress the cost required for an FPC and obtain in-plane uniformity of a detection signal of a pressing force even when a panel size is large.

### BRIEF DESCRIPTION OF DRAWINGS

FIG. 1 is a front view illustrating an example of a pressure detection panel according to an embodiment of the present invention.

FIG. 2 is a diagram illustrating a state of strain when a vicinity of one end portion of one side of a surface panel is pressed.

FIG. 3 is a diagram illustrating a state of strain when a vicinity of an intermediate portion of one side of the surface panel is pressed.

FIG. 4 is a diagram illustrating an example of a formation pattern of a strain sensor.

FIG. 5 is a front view illustrating another example of the pressure detection panel according to the embodiment of the present invention.

FIG. 6 is a front view illustrating a modified example of the pressure detection panel according to the embodiment of the present invention.

FIG. 7 is a front view illustrating a conventional pressure detection panel.

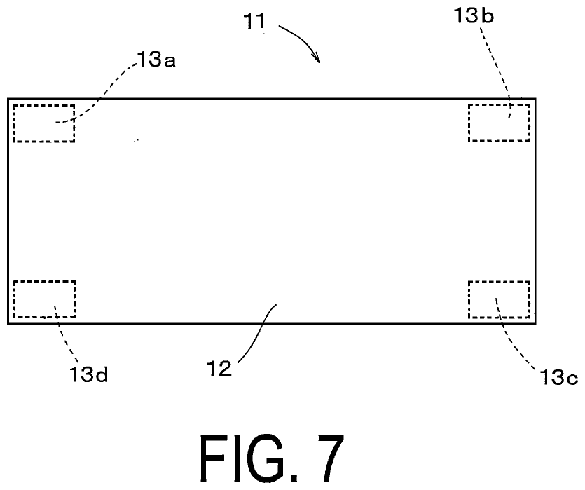

### DESCRIPTION OF EMBODIMENTS

### First Embodiment

Hereinafter, an embodiment of the present invention will be described with reference to the drawings.

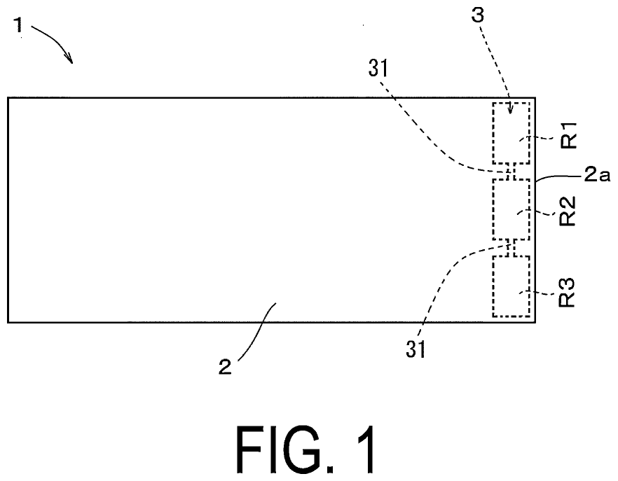

FIG. 1 illustrates an example of a pressure detection panel. A pressure detection panel 1 illustrated in FIG. 1 includes a surface panel 2 and a strain sensor 3. The pressure detection panel 1 is, for example, an electronic device, such as a display, a control switch, a handy terminal, or a console for manufacturing equipment. In the following description, a side where an input surface (an operating surface described later) of the electronic device is positioned will be referred to as a “front surface side.” This “front surface side” is also a side facing a user who operates the electronic device.

### Surface Panel

The surface panel 2 is a plate-shaped member arranged on the frontmost surface side in the pressure detection panel 1. The surface panel 2 has an operating surface on the surface on the front surface side thereof. The operating surface is a surface touched (to be an operation target) by, for example, a finger of the user when the user inputs a predetermined operation to the electronic device. The surface panel 2 illustrated in FIG. 1 has a quadrangular shape having a long side and a short side. As a material of the surface panel 2, for example, a resin material, such as polymethyl methacrylate or polycarbonate, can be used. The material is not limited to the above-described material as long as the material is elastically deformable to such an extent that the strain sensor 3 can detect a pressing force applied to the operation surface in a state where an end portion of the surface panel 2 is supported. For example, a thin glass may be used. Since the surface panel 2 has the operation surface, it is preferable that the surface panel 2 has scratch resistance, an antifouling property, and the like. When a display device is arranged behind the surface panel 2, the surface panel 2 preferably also has transparency.

### Strain Sensor

One strain sensor 3 is arranged in a strip shape along one side of the surface panel 2 on a back surface of the surface panel 2. In the example of the strain sensor 3 illustrated in FIG. 1, the strain sensor 3 is arranged along a right short side 2a of the surface panel 2. Therefore, since only one strain sensor 3 is provided, a width of an FPC for connection with an external device can be reduced, which saves cost.

In FIG. 1, the strain sensor 3 includes a total of three sensitive units R1, R2, and R3, one at an intermediate portion and one at each of both end portions in a direction parallel to the right short side 2a. The adjacent sensitive units, that is, the sensitive units R1 and R2 and the sensitive units R2 and R3 are mutually connected in series by wiring lines 31. The broken lines drawn in FIG. 1 do not indicate a shape or the size of the strain sensor 3, but schematically indicate the arrangement relationship between the sensitive units R1, R2, and R3 and the wiring lines 31 constituting the strain sensor 3.

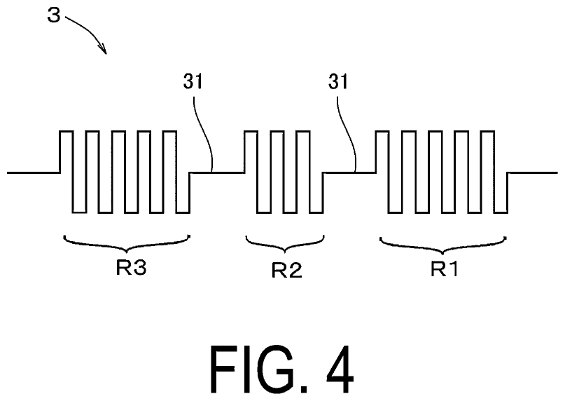

The pattern of the sensitive units R1, R2, and R3 of the strain sensor 3 can be, for example, as illustrated in FIG. 4, elements formed by repeatedly folding a linear resistor in parallel.

The pattern of the sensitive units R1, R2, and R3 is a pattern that includes a plurality of overlapping portions formed in parallel to one another by being folded back in a zigzag shape in plan view, and the arrangement direction of the plurality of overlapping portions matches an extension direction of the strain sensor 3, that is, the direction along the right short side 2a of the surface panel 2 illustrated in FIG. 4. The strain sensor 3 measures the change in resistance value caused by slight expansion and contraction of lengths of the resistors of the sensitive units R1, R2, and R3 due to deformation of the surface panel 2. Then, to increase the variation of the resistance value by connecting many changing portions in series, the linear resistors of the sensitive units R1, R2, and R3 are folded back. That is, the sensitivity of the sensitive units R1, R2, and R3 is improved by employing the folded pattern.

The resistors constituting the sensitive units R1, R2, and R3 can be formed of, for example, a material containing Cr (chromium), a material containing Ni (nickel), or a material containing both Cr and Ni. Examples of the material containing Cr include a Cr mixed phase film. Examples of the material containing Ni include Cu—Ni (copper nickel). Examples of the material containing both Cr and Ni include Ni—Cr (nickel chromium). In addition, other known materials used for the sensitive unit can be used for the resistor.

A thickness of the resistor is not particularly limited, but can be, for example, about 0.05 μm to 3 μm.

As a material of the respective wiring lines 31 that connect the sensitive units R1 and R2 and the sensitive units R2 and R3 in series, the material same as the resistors of the sensitive units R1, R2, and R3 can be used, and the wiring lines 31 can be formed in the same process.

As described above, in the pressure detection panel 1 of the present embodiment, since the strain sensor 3 includes the three sensitive units at the intermediate portion and both end portions of one side of a display panel 2, it is possible to adjust the sensitivities in the strain sensor 3 to be different so as to obtain in-plane uniformity of a detection signal of a pressing force even when the panel size is large.

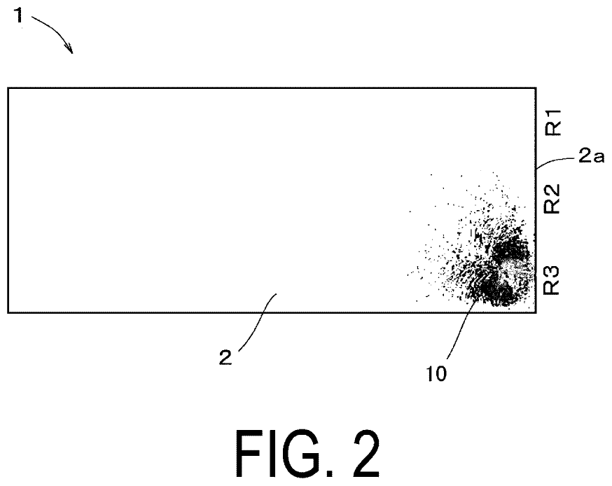

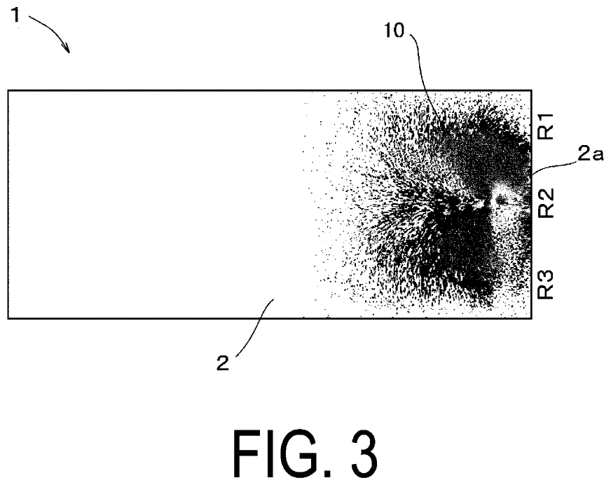

To further describe the adjustment for the sensitivities in the strain sensor 3 to be different in the present embodiment, as illustrated in FIG. 4, in a longitudinal direction of the strain sensor 3, respective sections in which the sensitive units R1, R2, and R3 are provided are longer at both end portions than at the intermediate portion. That is, the respective sections in which the sensitive units R1 and R3 are provided are made longer than the section in which the sensitive unit R2 is provided. This is because the surface panel 2 is relatively more likely to be deformed during pressing at the intermediate portion in the direction parallel to one side of the display panel 2 than both end portions in the direction parallel to the one side (see FIG. 3), and thus the detection sensitivity of the strain sensor 3 is likely to be sufficiently obtained without increasing the size of the sensitive unit R2 (which is equal to the increase in the change in the resistance value). Conversely, since the surface panel 2 is relatively less likely to be deformed during pressing at both end portions in the direction parallel to the one side of the display panel 2 than the central portion in the direction parallel to the one side (see FIG. 2), the detection sensitivity of the strain sensor 3 cannot be sufficiently obtained unless the sizes of the sensitive units R1 and R3 are increased (which is equal to the increase in the change in the resistance value). Dark portions in FIGS. 2 and 3 indicate the state of strain in which R3 and the vicinity of R2 are pressed, respectively.

By adjusting in this way, the sensitivities of the sensitive units provided at both end portions in the direction parallel to the one side of the surface panel 2 can be increased, and the sensitivity of the sensitive unit provided at the intermediate portion in the direction parallel to the one side can be decreased. As a result, even when the panel size is large, the in-plane uniformity of the detection signal of the pressing force can be obtained.

If the sensitive units R1, R2, and R3 of the strain sensor 3 were not separated by the wiring lines 31 but another sensitive unit is provided between the sensitive units R1 and R2 and another sensitive unit is provided between the sensitive units R2 and R3 to constitute one uniformly continuous sensitive unit, the change in the detected resistance value would be as follows.

That is, when the vicinity of the end portion of any of both end portions of the strain sensor 3 is pressed, only the resistance value of R1 or R3 changes. However, when the vicinity of the intermediate portion of the strain sensor 3 is pressed, not only the change in the resistance value of R2 but also the change in the resistance values between R1 and R2 and between R2 and R3 are included, and therefore the difference becomes large and the pressing force cannot be accurately detected.

On the other hand, when the sensitive units R1, R2, and R3 of the strain sensor 3 are separated by the wiring lines 31 with the sufficient distance as in the present embodiment, not only does this cause only the change in the resistance value of R1 or R3 when the vicinity of the end portion of any of both end portions of the strain sensor 3 is pressed, but also only the change in the resistance value of R2 when the vicinity of the intermediate portion of the strain sensor 3 is pressed. Thus, the difference becomes small, and therefore the pressing force can be accurately detected.

Regarding the separation of the sensitive units R1, R2, and R3 by the wiring lines 31, in the longitudinal direction of the strain sensor 3, the section in which each wiring line 31 is provided is preferably one third or more of the minimum section among the respective sections in which the sensitive units R1, R2, and R3 are provided. Within this range, the effect of separating the sensitive units R1, R2, and R3 is further improved.

### Second Embodiment

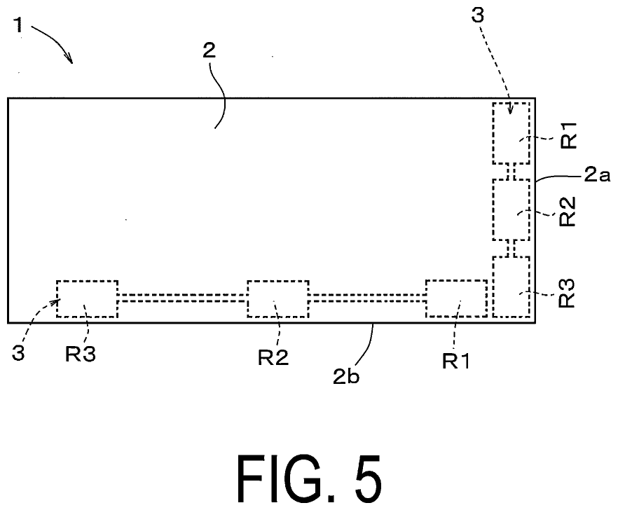

Further, in the first embodiment, only one strain sensor 3 is arranged on the back surface of the surface panel 2 in the strip shape along the right short side 2a of the surface panel 2 (see FIG. 1), but the pressure detection panel 1 of the present invention is not limited thereto. For example, the strain sensor 3 may be further arranged on at least one of the remaining sides of the operation panel 2. In the example illustrated in FIG. 5, one strain sensor 3 is arranged in a strip shape along each of the right short side 2a and a lower long side 2b of the surface panel 2.

By the configuration of arranging the strain sensor 3 on the other side in this way, the pressing force can be detected more accurately. This is because the strain sensor 3 arranged on the other side may perform detection more easily depending on a place where a pressing force is applied by a finger or the like on the surface panel 2, and the pressing force can be detected even if any place is pressed.

### Modified Example

In the first and second embodiments, the sensitive units R1, R2, and R3 of the strain sensor 3 and the respective wiring lines 31 are formed directly on the back surface of the surface panel 2, but the configuration is not limited thereto. For example, the sensitive units R1, R2, and R3 and the wiring lines 31 may be formed on a base material, such as a resin film, and the base material may be attached to the back surface of the surface panel 2 with an adhesive. In this case, since the strain sensor 3 is formed as a separate member from the surface panel 2, the strain sensor 3 can be manufactured in multi-piece, and the defective rate of the pressure detection panel is reduced, resulting in low cost.

Further, in the first and second embodiments, the sensitive units R1, R2, and R3 of the strain sensor 3 are elements formed by repeatedly folding the linear resistor in parallel as illustrated in FIG. 4, but the configuration is not limited thereto. For example, it may be formed by various sensitive unit patterns in the known strain sensor.

Further, in the first and second embodiments, the shape of the surface panel 2 is a quadrangle having long sides and short sides, but the configuration is not limited thereto. For example, the shape of the surface panel 2 may be a polygon, such as a triangle, a square, a pentagon, or a hexagon.

In the first and second embodiments, in the longitudinal direction of the strain sensor 3, the respective sections in which the sensitive units R1, R2, and R3 are provided are longer at both end portions than at the intermediate portion. However, in a case where the surface panel 2 has a special shape having an opening, a protruding portion, or the like, or a case where the surface panel 2 is partially significantly different in thickness, it is considered that the strain of the surface panel 2 generated when a pressing force is applied to the surface panel 2 by a finger or the like is different from the strain generated in the surface panel 2 used in the general pressure detection panel 1. In this case, the lengths of the respective sections in which the sensitive units R1, R2, and R3 are provided may be appropriately adjusted at a ratio different from those in the first and second embodiments to achieve the in-plane uniformity of the detection signal of the pressing force.

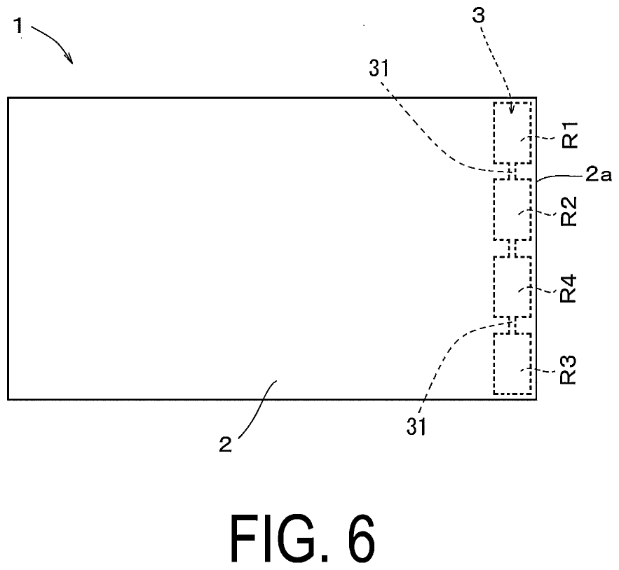

In the first and second embodiments, the strain sensor 3 includes the total of the three sensitive units R1, R2, and R3, one at each of the intermediate portion and both end portions. Since there are only the three sensitive units, the distance between the mutual sensitive units can be easily obtained, and the pressing force can be detected more accurately. However, the pressure detection panel 1 of the present embodiment is not limited thereto. For example, when the panel size of the surface panel 2 is further increased, the strain sensor 3 may have two or more sensitive units in the intermediate portion and one or more sensitive units in each of both end portions. For example, FIG. 6 is a case where two sensitive units R2 and R4 are provided in the intermediate portion.

The present invention can be changed in various ways without departing from the gist of the invention. In particular, the plurality of embodiments and modified examples described herein can be combined randomly with one another as necessary.

### REFERENCE SIGNS LIST

1, 11 Pressure detection panel
2, 12 Surface panel
3, 13a to 13d Strain sensor
31 Wiring line
R1, R2, R3, R4 Sensitive unit

1. A pressure detection panel, comprising:
a surface panel; and
a strain sensor arranged on a back surface of the surface panel in a strip shape along one side of the surface panel, wherein
the strain sensor includes sensitive units at an intermediate portion and both end portions in a longitudinal direction, and the adjacent sensitive units are mutually connected in series by a wiring line.

2. The pressure detection panel according to claim 1, wherein
at least one sensitive unit of the strain sensor is an element formed by repeatedly folding a linear resistor in parallel.

3. The pressure detection panel according to claim 1, wherein
in the longitudinal direction of the strain sensor, respective sections where the sensitive units are provided are longer at both the end portions than at the intermediate portion.

4. The pressure detection panel according to claim 1, wherein
in the longitudinal direction of the strain sensor, respective sections where the wiring line is one third or more of a minimum section among the respective sections where the sensitive units are provided.

5. The pressure detection panel according to claim 1, wherein
the surface panel has a quadrangular shape.

6. The pressure detection panel according to claim 1, wherein
the strain sensor is further arranged on at least one side of remaining sides of the surface panel.

7. The pressure detection panel according to claim 1, wherein
the strain sensor includes a total of three sensitive units, one at each of the intermediate portion and both the end portions.

8. The pressure detection panel according to claim 1, wherein
the strain sensor includes a total of four or more sensitive units, two or more at the intermediate portion, and one or more at each of both the end portions.

9. The pressure detection panel according to claim 1, wherein the strain sensor measures a change in a resistance value of at least one sensitive unit.

10. The pressure detection panel according to claim 9, wherein the change in the resistance value is caused by an expansion or a contraction of a length of the at least one sensitive unit.

11. The pressure detection panel according to claim 1, wherein the sensitive units are resistors having a thickness of 0.05 μm to 3 μm.

12. The pressure detection panel according to claim 2, wherein the at least one sensitive unit of the strain sensor formed by repeatedly folding the linear resistor in parallel includes a length of the folded linear resistor.

13. The pressure detection panel according to claim 12, wherein the length of the at least one sensitive unit is adjustable so as to adjust a sensitivity of the at least one sensitive unit.

14. The pressure detection panel according to claim 1, further comprising a base material attached to the surface panel, wherein the sensitive units are formed on the base material.

15. A strain sensor for use with a pressure detection panel, the strain sensor comprising:
a first end sensitive unit;
a second end sensitive unit positioned opposite the first end sensitive unit in a longitudinal direction of the strain sensor;
an at least one intermediate sensitive unit positioned between the first end sensitive unit and the second end sensitive unit; and
at least one wiring line to connect the first end sensitive unit, the second end sensitive unit, and the at least one intermediate sensitive unit,
wherein each of the first end sensitive unit, the second end sensitive unit, and the at least one intermediate sensitive unit is an element having a length formed by repeatedly folding a linear resistor in parallel.

16. The strain sensor according to claim 15, wherein a sensitivity of each of the first end sensitive unit, the second end sensitive unit, and the at least one intermediate sensitive unit is adjusted according to the length of the element of the respective sensitive unit.

17. The strain sensor according to claim 15, wherein the length of the first end sensitive unit and the second end sensitive unit is longer than the at least one intermediate sensitive unit.

18. The strain sensor according to claim 15, wherein the at least one intermediate sensitive unit includes a first intermediate sensitive unit and a second intermediate sensitive unit positioned between the first end sensitive unit and the second end sensitive unit.

19. A pressure detection panel comprising:
a surface panel; and
a first strain sensor arranged on a back surface of the surface panel in a strip shape along a first side of the surface panel,
wherein the strain sensor includes
a first end sensitive unit;
a second end sensitive unit positioned opposite the first end sensitive unit in a longitudinal direction of the strain sensor;
an at least one intermediate sensitive unit positioned between the first end sensitive unit and the second end sensitive unit; and
at least one wiring line to connect the first end sensitive unit, the second end sensitive unit, and the at least one intermediate sensitive unit,
wherein each of the first end sensitive unit, the second end sensitive unit, and the at least one intermediate sensitive unit is an element formed by repeatedly folding a linear resistor in parallel.

20. The pressure detection panel according to claim 19, further comprising
a second strain sensor arranged on the back surface of the surface panel in a strip shape along a second side of the surface panel.
